(19) United States
(12) Patent Application Publication
(10) Pub. No.: US 2020/0145556 A1
(43) Pub. Date: May 7, 2020

(54) INFORMATION PROCESSING APPARATUS, NON-TRANSITORY COMPUTER-READABLE RECORDING MEDIUM STORING MONITOR CONTROL PROGRAM FOR INFORMATION PROCESSING APPARATUS, AND MONITOR CONTROL METHOD

(71) Applicant: SHARP KABUSHIKI KAISHA, Sakai City (JP)

(72) Inventor: SOHICHI YOSHIMURA, Sakai City (JP)

(21) Appl. No.: 16/665,301

(22) Filed: Oct. 28, 2019

(30) Foreign Application Priority Data
Nov. 1, 2018 (JP) 2018-206569

(51) Int. Cl. H04N 1/44; H04N 1/00

(52) U.S. Cl. CPC H04N 1/4433; H04N 2201/0094; H04N 1/00474; H04N 1/0048

(57) ABSTRACT

A multifunction peripheral of the present invention includes a monitor mode that monitors for a presence or absence of an intruder by utilizing a motion detector. The monitor mode is activated during a non-usage period when the multifunction peripheral is not in use. The monitor mode on the other hand is temporarily cancelled when a predetermined cancel condition is satisfied during the non-usage period. In a state in which the monitor mode is temporarily cancelled, the multifunction peripheral is returned to the monitor mode when the predetermined return condition is satisfied. The multifunction peripheral can in this way flexibly respond to the needs of a user who wants to use basic functions of the multifunction peripheral such as copy function when the multifunction peripheral is in the monitor mode.

### BACKGROUND OF THE INVENTION

### Field of the Invention

The present invention relates to an information processing apparatus, a non-transitory computer-readable recording medium storing a monitor control program for the information processing apparatus, and a monitor control method, and relates in particular to an information processing apparatus including a detector to detect the presence or absence of an intruder including a user (walk-up user) within a predetermined area around the machine main body and a monitor function having a function unlike the original function that monitors for an intruder by utilizing the detector, a non-transitory computer-readable recording medium storing a monitor control program for the information processing apparatus, and a monitor control method.

### Description of the Background Art

An example of this type of technology is disclosed in Japanese Unexamined Patent Application Publication No. 2007-79692. According to the technology disclosed in Japanese Unexamined Patent Application Publication No. 2007-79692, a multifunction peripheral (MFP) equipped with a detector for detecting a person including a user is utilized as a monitor. When an intruder (abnormality) is detected by the MFP serving as a monitor, the MFP notifies a control device coupled via a network of this intrusion. The control device performs the appropriate processing to convey the detection of the intruder over a wider area.

However, when the MFP is utilized as a monitor as described above and there is a request for example from a user wishing to use basic functions of the MFP such as a copy function. Satisfying this type of user request is extremely important for improving convenience for the user. However, the Japanese Unexamined Patent Application Publication No. 19 2007-79692 discloses no measures whatsoever for satisfying the user request.

Whereupon, an object of the present invention is to provide a novel information processing apparatus, a non-transitory computer-readable recording medium recording a monitor control program for the information processing apparatus, and a monitor control method capable of flexibly satisfying a request from a user wishing to use the basic functions of the MFP when a monitor function has been activated to monitor for the presence or absence of an intruder.

### SUMMARY OF THE INVENTION

In order to achieve the aforementioned object, the present invention includes a first aspect of the present invention relating to an information processing apparatus, a second aspect of the present invention relating to a monitor control program for the information processing apparatus, and a third aspect of the present invention relating to a monitor control method for the information processing apparatus.

Among these aspects, the first aspect of the present invention according to the information processing apparatus includes a period setter, a detector, and a reporter and a deactivator. The period setter sets a non-usage period that the information processing apparatus is not used. The detector detects whether a person including the user is present within a predetermined area around the information processing apparatus. The reporter reports a detection of a presence of a person when the detector detects the presence of the person during the non-usage period. The deactivator deactivates the reporter when a predetermined deactivation condition is satisfied during the non-usage period.

A plurality of deactivation conditions may be set in the first aspect of the present invention. In this case, the deactivator preferably deactivates the reporter when at least one or all of the plurality of deactivation conditions is satisfied.

Also, the first aspect of the present invention may further include a limiter. The limiter limits functions of the information processing apparatus when the reporter is set in a deactivated state by the deactivator.

In addition, when the plurality of the deactivation conditions set as described above and the reporter is deactivated because at least one of the plurality of the deactivation conditions is satisfied, the limiter may limit functions of the information processing apparatus corresponding to the extent of satisfaction of the deactivation conditions.

Here, the deactivation condition includes for example, a first time condition that is the reaching of a predetermined first time

The deactivation condition also includes a first operation condition that a predetermined first operation is performed for the information processing apparatus

In addition, the deactivation condition may include a first information entry condition that a predetermined first information is input for the information processing apparatus.

The first aspect of the present invention may further include an activator. In a state in which the reporter is deactivated by the deactivator, the activator activates the reporter when a predetermined activation condition is satisfied.

Here, this activation condition includes for example a second time condition which is the reaching of a predetermined second time.

The activation condition also may include a second operating condition in which a predetermined second operation is performed for the information processing apparatus.

The activation condition may include a non-usage condition that the information processing apparatus is not used for a predetermined period.

The first aspect of the present invention may further include a storage device. The storage device stores history information relating to the history of the process performed by the information processing apparatus when the reporter is in the deactivated state by the deactivator.

The storage device may be configured to store the history information when a predetermined storage condition is satisfied.

Here, the storage condition for example includes a second information entry condition that a predetermined second information is input for the information processing apparatus.

The information processing apparatus according to the first aspect of the present invention is for example a multifunction peripheral (MFP).

The non-transitory computer-readable recording medium that records the monitor control program for an information processing apparatus according to the second aspect of the present invention implements a period setting procedure, a report procedure, and a deactivation procedure on the computer for the information processing apparatus. The information processing apparatus described here includes a detector. The detector detects whether a person including the user is present within a predetermined area around the information processing apparatus. The period setting procedure then sets a non-usage period that the information processing apparatus is not used. The report procedure that reports a detection of a presence of a person when the detector detects the presence of the person during the non-usage period. The deactivation procedure does not execute the report procedure when a predetermined deactivation condition is satisfied during the non-usage period.

The monitor control method for the information processing apparatus according to the third aspect of the present invention includes setting, reporting, and deactivating. The information processing apparatus described here includes a detector. The detector detects whether a person including the user is present within a predetermined area around the information processing apparatus. The setting then sets the non-usage period that the information processing apparatus is not used. The reporting reports a detection of a presence of a person when the detector detects the presence of the person during the non-usage period. The deactivating then does not execute the reporting when the predetermined deactivation condition is satisfied during the non-usage period.

The present invention as described above is capable of flexibly responding to the user's request to utilize a basic function of the information processing apparatus when the monitor function for monitoring the presence of an intruder is activated. The convenience for the user is in this way improved.

### BRIEF DESCRIPTION OF THE DRAWINGS

FIG. 1 is an external perspective view of a multifunction peripheral (MFP) according to a first embodiment of the present invention;

FIG. 2 is a view of the detection area by a motion detector of the first embodiment as seen from above;

FIG. 3 is a block diagram showing an electrical configuration of the MFP according to the first embodiment;

FIG. 4 is a diagram showing an example of a home screen when a monitor mode in the first embodiment is temporarily canceled;

FIGS. 5A and 5B are screen views showing examples of the display screen when the monitor mode in the first embodiment is temporarily canceled, and in which FIG. 5A is a check screen and FIG. 5B is a password entry screen;

FIG. 6 is a diagram showing an example of the home screen when the monitor mode in the first embodiment is temporarily canceled by way of a predetermined procedure;

FIG. 7 is a diagram showing an example of a setting screen in the first embodiment;

FIG. 8 is a memory map showing a concept view of the configuration within the Random Access Memory (RAM) of the main controller in the first embodiment;

FIG. 9 is a memory map showing a concept view of the configuration within the RAM of the sub controller in the first embodiment;

FIG. 10 is a flowchart showing the flow in a portion of the monitor control process executed by the Central Processing Unit (CPU) of the main controller in the first embodiment;

FIG. 11 is a flowchart showing the flow in another portion of the monitor control process in the first embodiment;

FIG. 12 is a flowchart showing the flow in another portion of the monitor control process in the first embodiment;

FIG. 13 is a flowchart showing the flow of the remaining portion of the monitor control process in the first embodiment;

FIG. 14 is a flowchart showing the flow in the monitor process executed by the CPU of the main controller in the first embodiment;

FIG. 15 is a flowchart showing the flow in the report process executed by the CPU of the main controller in the first embodiment;

FIGS. 16A and 16B are screen views showing examples of the display screen when returning to the monitor mode in the second embodiment of the present invention, in which FIG. 16A is a check screen and FIG. 16B is a password entry screen;

FIG. 17 is a flowchart showing a portion of the monitor control process executed by the CPU of the main controller in the second embodiment.

### DESCRIPTION OF THE PREFERRED EMBODIMENTS

### First Embodiment

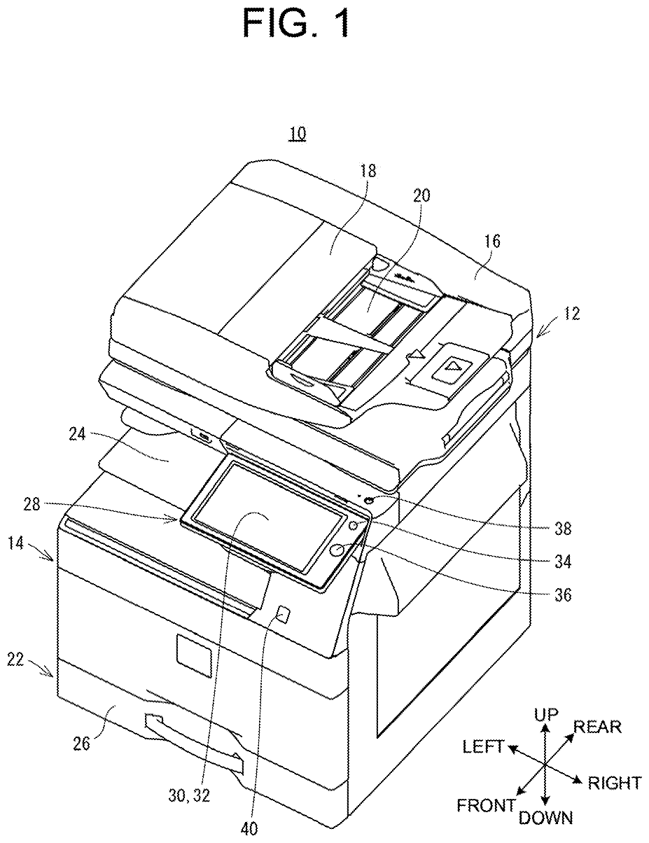

The first embodiment of the present invention is described using a multifunction peripheral (hereafter MFP) 10 shown in FIG. 1 as an example. FIG. 1 is an external perspective view of the MFP 10 showing the front side, top side, and right side of the MFP 10. Namely, the vertical (up and down) direction in FIG. 1 corresponds to the vertical (up and down) direction of the MFP 10. The lower left direction in FIG. 1 corresponds to the front of the MFP 10, and the upper right direction in FIG. 1 corresponds to the rear of the MFP 10. Also, the upper left direction in FIG. 1 corresponds to the left of the MFP 10, and the lower right direction in FIG. 1 corresponds to the right of the MFP 10.

The MFP 10 has a plurality of functions such as a copy function, a printer function, an image scanner function, and a facsimile function. The MFP 10 therefore has an image scanner 12 as an image scan executor and an image former 14 as an image maker.

The image scanner 12 is mounted in the upper part (of housing) of the MFP 10. The image scanner 12 has a document table formed from transparent material such as glass not shown in the drawing. The document depressor cover 16 is attached to freely open and close by way of such as a hinge not shown in the drawing above the document table. The image scanner 12 performs image scanning processing that scans an image of a document (not shown in the drawing) placed on the document table and outputs two-dimensional image data matching the image. The image scanner 12 therefore includes an image scanner portion including a light source not shown in the drawing, a plurality of mirrors, an imaging lens, and a line sensor, etc. and also includes a drive mechanism that moves the image scanner portion.

Further, an automatic document feeder (ADF) 18 is provided in the document depressor cover 16. The ADF 18 includes a loading tray 20 that is capable of loading a plurality of document pages or more specifically documents in a sheet-shape, and feeds the document sheets placed on the loading tray 20 one by one to the image scanning position of the image scanner 12. The ADF 18 is an optional device and therefore might not be provided.

The image former 14 is mounted below the image scanner 12. The image former 14 performs an image forming processing that forms an image on sheets serving as the image recording medium not shown in the drawing that are supplied one by one from the paper feeder 22 by a known electrophotographic method. The image former 14 therefore includes a photosensitive drum, a charging device, an exposure device, a developing device, a transfer device, and a fixing device, etc. (not shown in the drawing). The paper after forming the image by the image former 14, or in other words the printed paper, is ejected to a paper tray 24. The method of the image former 14 is not limited to the electrophotographic method and it may perform the image forming processing for example by the inkjet method.

In the MFP 10 shown in FIG. 1, only one paper feed cassette 26 serving as the paper feeder 22 is provided however a plurality of paper feed cassettes 26 may be provided. The paper tray 24 is provided between the image scanner 12 and the image former 14. The paper tray 24 is in other words formed by an in-cylinder space between the image scanner 12 and the image former 14, however other structures may be utilized.

Moreover, an operator 28 in a substantially rectangular plate shape is provided at the front part of the MFP 10 and more specifically at the front part (of the housing) of the image scanner 12. The operator 28 has one main surface facing obliquely upwards. More specifically, the one main surface is mounted so that the one main surface is slightly inclined toward the front side of the MFP 10. A display 32 with a touch panel 30 is provided on the upper surface which is one main surface of the operator 28. A power saver button 34 and a home button 36 are provided on the upper surface of the operator 28.

The display 32 with the touch panel 30 is an integrated combination of a display 32 having a rectangular display surface and a sheet-shape touch panel 30 provided to overlap the display surface of the display 32. The touch panel 30 is one example of an operation receiver for receiving operation from a user using the MFP 10, and for example is an electrostatic capacitive type touch panel. The display 32 is one example of a display for displaying various information and for example is a liquid crystal display (LCD). The touch panel 30 is not limited to the electrostatic capacitive type and may utilize other types such as an electromagnetic induction type, a resistance film type, and an infrared ray type. The display 32 is also not limited to a liquid crystal display and may be rendered as an organic electroluminescence (EL) display.

The power saver button 34 for example is an electrostatic capacitive type switch that is one type of hardware key. The power saver button 34 is provided on the right side direction of the display 32 with the touch panel 30. The power saver button 34 is also one example of an operation receiver. More specifically, the power saver button 34 is an example of an operation receiver for shifting the operation mode of the MFP 10 from a normal mode described below, to a power saver mode, or from the power saver mode to the normal mode. Although not shown in the drawings, the power saver button 34 is provided for example with a light emitting diode (LED) as a backlight.

The home button 36 for example is an electrostatic capacitive type switch similar to the power saver button 34 and is provided on the right side direction of the display 32 with the touch panel 30 or namely is provided near the power saver button 34. The home button 36 is also provided and is also an example of the operation receiver. More specifically, the home button 36 is an example of the operation receiver for displaying the home screen 100 described below on the display 32. Although not shown in the drawings, the home button 36 includes a light-emitting diode (LED) as a backlight.

The user generally stands in front of the MFP 10 and utilizes the MFP 10, and in particular operates the operator 28. The operator 28 is provided with its upper surface slightly inclined toward the front side of the MFP 10 as described above so that the operability and visibility of the operator 28 by the user at that time are improved. The operator 28 is rotatable at the coupling portion with the image scanner 12 serving as the axis, to achieve a variable tilt angle of the upper surface within an appropriate range.

Further, a power button 38 is provided at an appropriate position on the MFP 10 such as a position near the coupling portion with the operator 28 at the image scanner 12. The power button 38 is also an example of the operation receiver. Specifically, the power button 38 is one example of an operation receiver that turns the power supply of the MFP 10 on or off, or more accurately, shifts the MFP 10 operation mode from the power saver mode described below, to the normal mode, or shifts from the normal mode to the power saver mode. The power button 38 is for example, a momentary type push button switch which is one type of hardware key.

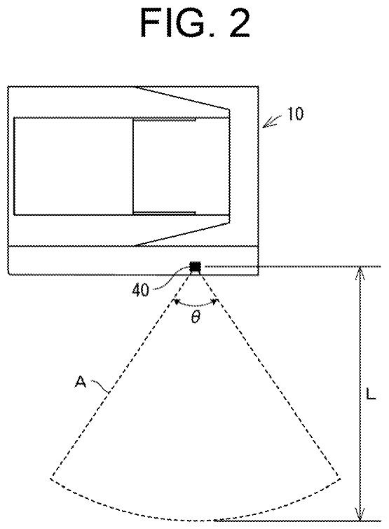

Further, a motion detector 40 is also provided at an appropriate position on the MFP 10, for example at a position below the operator 28 at the front part of the MFP 10. The motion detector 40 is one example of a detector for detecting whether a person including a user is present around the MFP 10. Specifically, as shown in FIG. 2, the motion detector 40 forms a detection area A on the front side of the MFP 10 where the user is standing. The motion detector 40 outputs a detection signal according to whether a person is present in the detection area A. The motion detector 40 is for example a pyroelectric sensor which is one type of an infrared ray type sensor.

FIG. 2 is an upper view of the detection area A or namely the detection area A in the horizontal direction. In FIG. 2, the detection area A in the horizontal direction has an attractive fan shape however the actual fan shape is a slightly deformed shape. The directional angle (center angle) θ (theta) of the detection area A in the horizontal direction is mainly determined by the specifications of the motion detector 40 and the mounting structure of the motion detector 40. The directional angle can be changed within a certain range depending on the electrical settings of the motion detector 40 (drive power, gain of the amplifier circuit, etc.). Though not shown in the drawings the same applies to the detection area A in the vertical direction. Also, the distance (detection distance) L of the detection area A is also mainly determined by the specifications of the motion detector 40 and the mounting structure of the motion detector 40, but also depends on the electric setting of the motion detector 40 and can therefore be changed to some extent.

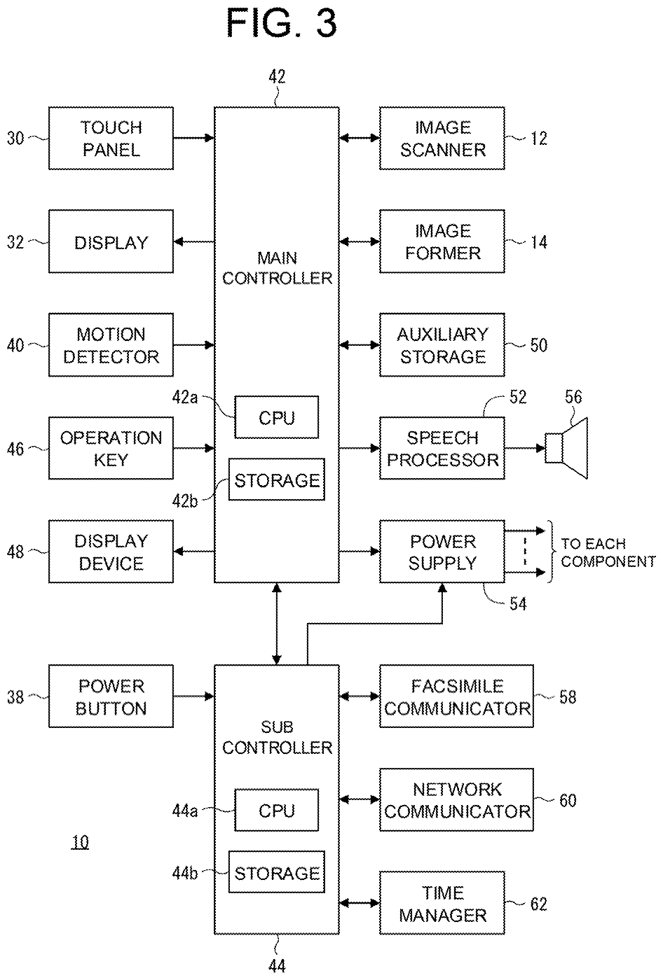

FIG. 3 is a block diagram showing the electrical configuration of the MFP 10. In FIG. 3, elements (components) not directly related to the present invention are not shown. A portion of the components including the touch panel 30, the display 32 and the motion detector 40 are provided with auxiliary components such as a drive circuit, but the auxiliary components are also omitted from the drawing.

As shown in FIG. 3 the MFP 10 includes a main controller 42 and a sub controller 44, and is one example of a controller in which the main controller 42 and the sub controller 44 mutually cooperate to control the overall functions of the MFP 10. The main controller 42 and the sub controller 44 are for this reason coupled to each other and communicate appropriately with each other.

Among these components, the main controller 42 is coupled to the image scanner 12 and the image former 14. In addition, the main controller 42 is coupled to the touch panel 30, the display 32 and the motion detector 40. The main controller 42 is coupled to an operation key 46 and a display device 48. In addition, the main controller 42 is coupled to an auxiliary storage 50, a speech processor 52, and a power supply 54.

The main controller 42 includes a central processing unit (CPU) 42a as a control executor. From here onwards, the CPU 42a of the main controller 42 is referred to as the “main CPU 42a”. In addition, the main controller 42 includes a storage 42b as a main storage that can be directly accessed by the main CPU 42a. The storage 42b includes for example, a Read Only Memory (ROM) and a Random Access Memory (RAM) not shown in the drawings. In the ROM, a main control program (firmware) for controlling the operation of the main CPU 42a is stored in advance. The RAM includes a work area and a buffer area that are utilized when the main CPU 42a executes a processing based on the main control program.

The operation key 46 is an operation receiver other than the touch panel 30 and the power button 38. In other words, an operation receiver other than the touch panel 30 and the power button 38 are summarized into one component for purposes of convenience. The operation key 46 includes the power saver button 34 and the home button 36. The operation key 46 including the power saver button 34 and the home button 36 may be provided with auxiliary components such as a drive circuit however the auxiliary components are omitted from the drawing.

The display device 48 is a light emitter including the hack light for the power saver button 34 and the back light for the home button 36. The display device 48 in other words expresses the light emitter in one component for purposes of convenience. The display device 48 may be provided with auxiliary components such as a drive circuit however the auxiliary components are omitted from the drawings.

The auxiliary storage 50 is one example of an auxiliary storage including a non-volatile memory such as a hard disk or a flash memory not shown in drawings. Various data are stored in the auxiliary storage 50 according to control by the main CPU 42a. The data stored in the auxiliary storage 50 includes external job data such as print jobs and jobs accepted by facsimile in the protect processing described below.

The speech processor 52 is an example of a speech processor that outputs voice (synthesized voice) such as a voice guidance related to the instruction manual for the MFP 10 or a warning message described below from a speaker 56. In other words, the speech processor 52 serves as audio outputter for outputting audio along with the speaker 56. The speaker 56 is not shown in FIG. 1, however the speaker 56 may be provided for example, on the front side or the left or right side of housing of the MFP 10.

The power supply 54 is an example of a power controller for supplying power (electrical power) to each component of the MFP 10 or stopping the power supply according to control by the main CPU 42a or the sub CPU 44a described below. The power supply 54 therefore includes a power supply circuit (not shown in drawing) that receives power from a commercial power supply and generates power corresponding to each component from the commercial power supply. The power supply 54 supplies the power generated by the power supply circuit to each component or stops supplying the power.

Similar to the main controller 42, the sub controller 44 also includes a CPU 44a as a control executor. The CPU 44a of the sub controller 44 is here referred to as the “sub CPU 44a”. The sub CPU 44a includes a storage 44b as a main storage that can be directly accessed by the sub CPU 44a. The storage 44b for example includes a ROM and a RAM (not shown in drawing). In the ROM, the sub control program for controlling the operation of the sub CPU 44a is stored in advance. The RAM includes a work area and a buffer area that are utilized when the sub CPU 44a executes processing based on the sub control program.

The power button 38 is coupled to the sub controller 44. A facsimile communicator 58, a network communicator 60, and a time manager 62 are also coupled to the sub controller 44.

The facsimile communicator 58 is an example of a fax communicator that handles facsimile communication. The facsimile communicator 58 for this reason has a facsimile modem (not shown in drawing).

The network communicator 60 is an example of a network communicator that performs two-way communication by way of a network such as a Local Area Network (LAN) or the Internet. The network communicator 60 for this reason uses a Network Interface Card (NIC) (not shown in drawing).

The time manager 62 is an example of a time manager that manages the time (year-month-day-hours-minutes-seconds). The time manager 62 for this reason includes a Real Time Clock (RTC) (not shown in the drawing).

Now, the MFP 10 according to the first embodiment has three modes as its operation modes: a normal mode, a power saver mode, and a maximum power saver mode.

The normal mode is the mode when the MFP 10 is in a normal state. In the normal mode, the MFP 10 is in warm-up state or in other words, can instantly respond to operations for the touch panel 30 or external jobs. In other words, power is supplied to each component from the power supply 54 to allow an immediate response. Therefore when the touch panel 30 is operated by the user, the MFP 10 immediately executes processing matching the operation. Also, upon receiving an external job, the MFP 10 immediately executes processing matching the job.

The power saver mode is the mode when the MFP 10 is in the power saver state or namely a state in which power consumption of the MFP 10 is suppressed. In the power saver mode, the power from the power supply 54 is supplied to only certain components including the main controller 42, the sub controller 44, the power saver button 34, the back light for the power saver button 34, the motion detector 40, the facsimile communicator 58, the network communicator 60, and the time manager 62. Then for example, the MFP 10 only waits for an external job such as a print job or a facsimile receiving job, detects the presence or absence of a person by the motion detector 40, waits for operation of the power saver button 34, flashes the back light for the power saver button 34, and waits for operation of the power button 38. Here, for example, when an external job is accepted, the MFP 10 warms up and then executes processing according to the job. When the motion detector 40 detects the presence of a person, the MFP 10 shifts from the power saver mode to the normal mode and starts warmup. The shortens the time needed to complete warm-up of the MFP 10 when the user wants to use the MFP 10. In addition, in the power saver mode when the power saver button 34 is pressed, the MFP 10 shifts from the power saver mode to the normal mode. On the other hand, when the power saver button 34 is pressed in the normal mode, the MFP 10 shifts from the normal mode to the power saver mode. Also, in the normal mode, when the MFP 10 is not used for a predetermined power saving wait (or standby) period, the MFP 10 shifts from the normal mode to the power saver mode. The power saving waiting period can be arbitrarily set, and ordinarily is set in a range from several minutes to several dozen minutes.

The maximum power saver mode is a mode when power consumption of the MFP 10 is suppressed even further. In the maximum power saver mode, power from the power supply 54 is supplied only to the sub controller 44, the facsimile communicator 58, the network communicator 60, and the time manager 62. The MFP 10 at that time only waits for an external job and only waits for operation of the power button 38. Here, for example, when an external job is accepted, the MFP 10 warms up, and then executes the process according to the job. When the power button 38 is pressed, the MFP 10 shifts from the maximum power saver mode to the normal mode. On the other hand, when the power button 38 is pressed in the normal mode, the MFP 10 shifts from the normal mode to the maximum power saver mode. Further, in the power saver mode, the MFP 10 shifts from the power saver mode to the maximum power saver mode even if the power button 38 is pressed.

The MFP 10 configured as described above is installed for example, in an office. In the office, the MVP 10 is mainly used during working hours, and in particular is not used outside of normal working hours at midnight and on days the office is closed. The MFP 10 is therefore preferably in the maximum power saver mode during the non-usage periods when the MFP 10 is not in use.

Whereupon, the MFP 10 of the first embodiment includes an automatic mode switching function that sets the MFP 10 in the maximum power saver mode during the non-usage period when an optional period is set as the non-usage period, and sets the MFP 10 to the normal mode or the power saver mode during periods other than the non-usage period. As mentioned above, when the power saver button 34 is pressed in the normal mode or when the MFP 10 is not used during the power saver wait (or standby period), the MFP 10 shifts from the normal mode to the power saver mode. In the power saver mode, when the motion detector 40 detects a person, or when the power saver button 34 is pressed, the MFP 10 shifts from the power saver mode to the normal mode.

In addition, the MFP 10 of the first embodiment includes a monitor function that monitors the presence or absence of an intruder using the motion detector 40. The monitor function is activated during the above mentioned non-usage period. Specifically, the MFP 10 includes an operation mode called a monitor mode for implementing the monitor function in addition to three operation modes of the normal mode, the power saver mode, and the maximum power saver mode. If the setting that activates the monitor mode is made after setting the non-usage period, the MFP 10 will be in the monitor mode (not the maximum power saver mode) during the non-usage period. In the monitor mode, the power supply 54 supplies power only to some components including the main controller 42, the sub controller 44, the motion detector 40, the facsimile communicator 58, the network communicator 60, and the time manager 62. Also, when for example, the motion detector 40 detects the presence of a person, the MFP 10 regards the detected person as an intruder, and outputs a warning message from the speaker 56 including a predetermined voice (sound) announcing the situation. Also, if a setting has been made in advance to send a predetermined warning mail to an optional destination mail address, the warning mail will be sent to the preset mail address.

In monitor mode, the MFP 10 can also wait (standby) for an external job. When an external job is then accepted, the MFP 10 performs a protect process that stores the data for the external job in the auxiliary storage 50. The protect process prevents job data from external sources from leaking to an intruder and maintains the security of the data. The job data stored in the auxiliary storage 50 by the protect process is used for processing according to the job as specified by user operation after the non-usage period ends, in other words after the MFP 10 shifts to the normal mode.

On the other hand, when the MFP 10 is in the monitor mode, there may be a request from a user wishing to use an original function of the MFP 10 such as the copy function. According to the first embodiment, to satisfy the request, the monitor mode can be temporarily cancelled to allow using the original function of the MFP10. Specifically, when a predetermined condition for temporarily canceling the monitor mode is satisfied, the MFP 10 can temporarily cancel the monitor mode and use the original function of the MFP 10. At least one or all of the following three cancel conditions can be set as the predetermined conditions given here.

A first cancel condition is the reaching of a preset cancel time. Namely, the monitor mode is canceled when the cancel time is reached. Any optional time within the non-usage period can be set as the cancel time. The cancel time is one example of the first time of the present invention. The first cancel condition is one example of the first time condition according to the present invention or in other words, one example of the deactivation condition of the present invention.

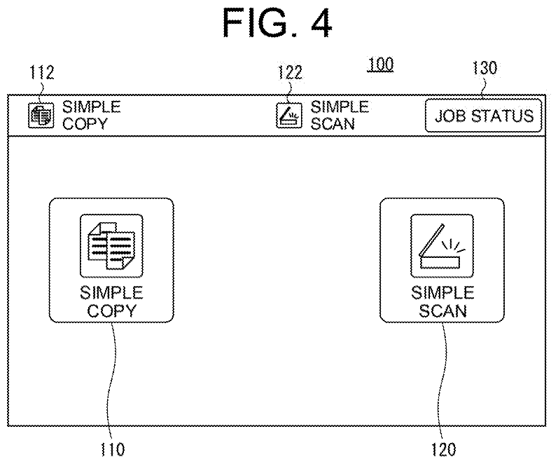

The functions of the MFP 10 however are limited if the monitor mode is canceled because the first cancel condition is satisfied or namely the cancel time has been reached. For example, only a portion of the functions including the copy function and the image scanner function of the MVP 10 can be used. The home screen 100 as shown in FIG. 4 is for this reason shown on the display 32 immediately after monitor mode is canceled. The home screen 100 includes just two buttons (icons) 110 and 112 in various sizes for selecting the copy function, and two buttons 120 and 122 in various sizes for selecting the image scanner function, and other portion of components. This is only a rough drawing so details are omitted however other components include a button 130 for checking the job status.

A second cancel condition is that a predetermined cancel operation is performed on the MFP 10. Namely, monitoring is canceled when a predetermined cancel operation is performed on the MFP 10 during the non-usage period. The cancel operation described here for example is a long-pressing of the power button 38 two times or a long-pressing of the power button 38 three times. The long-pressing of the power button 38 two times is the operation of holding down of the power button 38 for a relatively long time, for example of three seconds or more, for two consecutive times. The long-pressing of the power button 38 for three times is the operation of the holding down of the power button 38 for three consecutive times. The setting to apply either of the long-pressing the power button 38 two times or the long-pressing the power button 38 three times as the cancel operation is made beforehand. The second cancel condition is one example of the first operation condition of the present invention or in other words is one example of a deactivation condition. The cancel operation is the first operation condition according to the present invention.

When the second cancel condition is satisfied or namely, when the monitor mode is canceled because the cancel operation is performed on the MFP 10, the functions of the MFP 10 are limited the same as for the case that the above-mentioned first cancel condition is satisfied. Namely, the home screen 100 as shown in FIG. 4 is shown on the display 32 immediately after the monitor mode is canceled. Also, only a portion of the functions including the copy function and the image scanner function can be used.

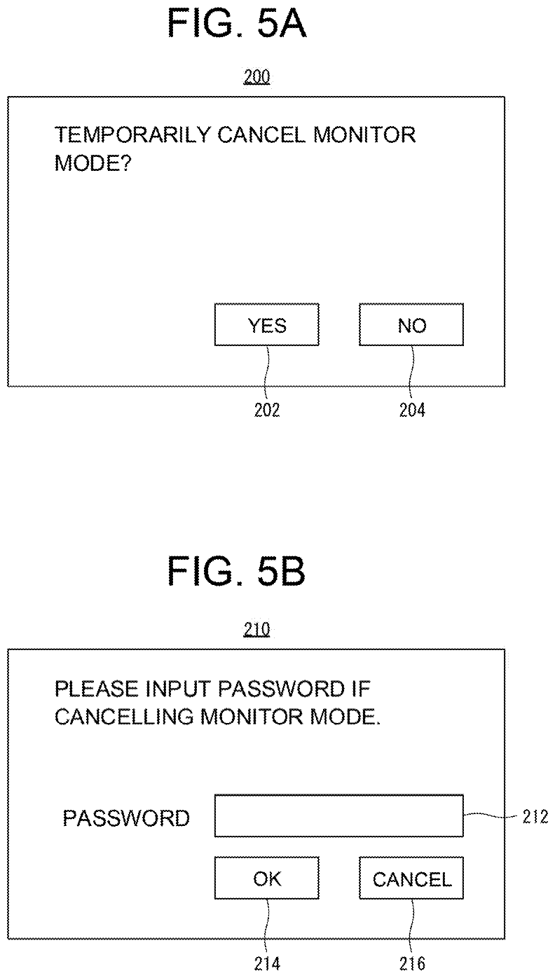

A third cancel condition is that the predetermined password is input to the MFP 10. Specifically, the predetermined password is input by operating the touch panel 30 after the pressing the power button 38 (short-pressing). More specifically, when the power button 38 is pressed, a check screen 200 as shown in FIG. 5A appears on the display 32. On the check screen 200, when the button 202 with the character string “YES” is pressed, or namely when the operation is performed on the touch panel 30; the password entry screen 210 as shown in FIG. 5B appears on the display 32 instead of the check screen 200. On the password entry screen 210, a predetermined password is input into the field 212 for inputting the password. When the button 214 with the character string “OK” is pressed after the password is input, the monitor mode is canceled when the so-called password authentication is successful. The third cancel condition of the present invention is an example of the first information entry condition according to the above or namely is an example of the deactivation condition. The password is an example of the first information of the present invention.

Incidentally, if the password entered in the field 212 of the password entry screen 210 does not match the preset password, an error message screen (not shown in the drawing) indicating that the password authentication has failed is shown on the display 32. The error message screen is displayed for a certain period of time, for example, from several seconds to several dozen seconds, instead of the password entry screen 210 or in the form of a dialog on the password entry screen 210. The MFP 10 then returns to the state before the power button 38 is pressed. Also, when the button 204 with the character string “NO” is pressed on the check screen 200 described above, the MFP 10 returns to the state before the power button 38 is pressed. On the password entry screen 210, even if the button 216 character string “CANCEL” is pressed, the MFP 10 returns to the state before the power button 38 is pressed.

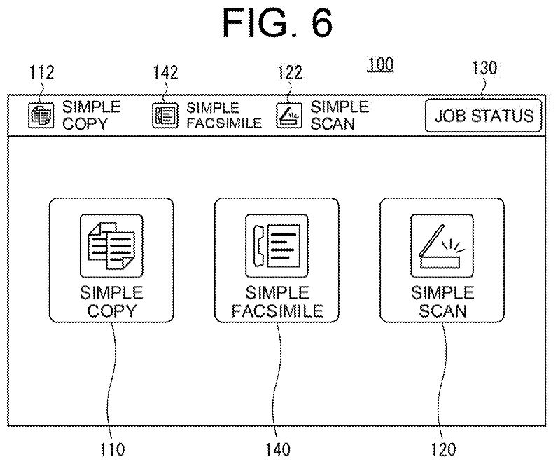

Unlike the case when the first cancel condition or the second cancel condition is satisfied, if the monitor mode is canceled when the third cancel condition is satisfied or namely when a predetermined password is input to the MFP 10, the functions of the MFP 10 are not limited. Namely, all the functions of the MET 10 can be used. Therefore, immediately after the monitor mode is canceled, the home screen 100 shown in FIG. 6 is shown on the display 32. The home screen 100 shown in FIG. 6 includes two buttons 140 of various sizes for selecting the facsimile function and various types of components not shown in FIG. 4. Note that a home screen 100 similar to that shown in FIG. 6 is shown on the display 32 even when the home button 36 is pressed in the normal mode. When the power saver button 34 is pressed in the power saver mode the MFP 10 shifts from the power saver mode to the normal mode. At this time, the same home screen 100 similar to that shown in FIG. 6 is shown on the display 32.

When the predetermined return condition is satisfied in the state where the monitor mode is canceled in this way, the MFP 10 returns to the monitor mode. Here, the so-called return condition depends on the cancel condition factors that canceled the monitor mode, or in other words, which of the first through the third cancel conditions is satisfied to cancel the monitor mode.

For example, when the monitor mode is canceled because the first cancel condition is satisfied, or namely when the cancel time is reached, the return condition for returning to the monitor mode is that the predetermined return time is reached. In other words, when the predetermined return time is reached, the MFP 10 returns to the monitor mode. The return time is an optional time after the cancel time during the non-usage period and is set in advance. The return time is an example of the second time according to the present invention. The return condition that the return time is reached is an example of the second time condition according to the present invention or in other words is an example of the activation condition.

Also, if the monitor mode is canceled because the second cancel condition is satisfied, or namely the cancel operation has been performed on the MFP 10, performing a predetermined return operation on the MFP 10 is the return condition for returning to the monitor mode. In other words, when a predetermined return operation is performed on the MFP 10, the MFP 10 returns to the monitor mode. The so-called return operation for example is the pressing of the power button 38. The pressing of the power button 38 may be a short pressing or a long pressing. The return operation is an example of the second operation according to the present invention. The return condition for performing the return operation is an example of the second operation condition according to the present invention or in other words is an example of the activation condition.

Further, the return condition in this case includes that the MFP 10 is not used for a predetermined return waiting (or standby) period. Namely, the NUT 10 returns to the monitor mode even when the MFP 10 is not used for the return waiting period. The so-called return waiting period as referred to here is, for example, from several minutes to several dozen minutes. The return waiting period is an example of a predetermined period according to the present invention. The return condition that the MFP 10 is not used during the return waiting period is an example of a non-operation condition according to the present invention or namely is an example of an activation condition.

When the third cancel condition is satisfied, or namely when the monitor mode is canceled due to input of the predetermined password to the MFP 10, the return condition for returning to the corresponding monitor mode is the same as the satisfying of the second cancel condition. Namely, when a predetermined return operation is performed on the MFP 10 or when the MFP 10 is not used during the predetermined return waiting period, the MFP 10 returns to the monitor mode.

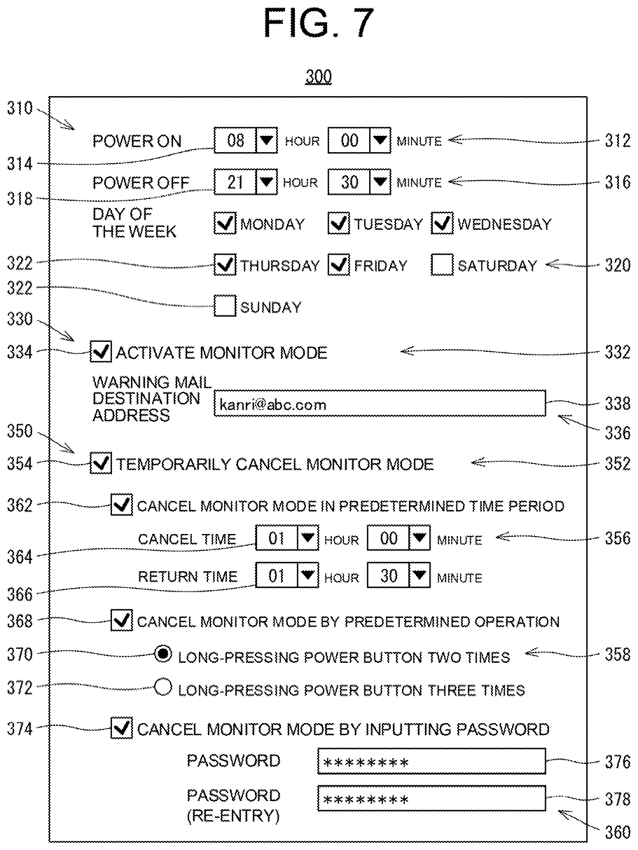

The setting screen 300 shown in FIG. 7 is provided for the temporary cancelling of the monitor mode, and the above-described automatic mode switching function. Namely, the setting screen 300 is used to set the automatic mode switching function, the monitor mode and the temporary cancelling of the monitor mode. The setting screen 300 is shown for example on the display 32. Therefore, the touch panel 30 can be operated to make settings on the setting screen 300 displayed on display 32. The setting screen 300 is also displayed on a computer (display) as an external device (not shown in drawing) coupled via a network. The setting screen 300 can therefore also be operated from the computer.

As shown in FIG. 7, the setting screen 300 includes a setting area 310 relating to the automatic mode switching function, a setting area 330 relating to the monitor mode, and a setting area 350 relating to the temporary canceling of the monitor mode.

A setting area 310 relating to the automatic mode switching function is provided, for example, in the upper part of the setting screen 300. The setting area 310 includes an area 312 that sets the time for turning on the power of the MFP 10 or more strictly speaking, the time for shifting the operation mode of the MFP 10 from the maximum power saver mode to the normal mode. The time to turn on the power of the MFP 10 can be set by inputting an optional time into the combo box 314 provided in the area 312. The setting area 310 also includes an area 316 that sets the time for turning off the power of the MFP 10 or more strictly speaking, the time when the operation mode of the MFP 10 is set to the maximum power saver mode. The time to turn off the power of the MFP 10 can be set by inputting an optional time into the combo box 318 provided in the area 316. The setting area 310 further includes an area 320 that sets the day of the week for applying the time to turn on the power of the MFP 10 set in the area 312 and the time to turn off the power of the MFP 10 set in the area 316. Inputting a check mark in the check box 322 corresponding to the respective day of the week set in the area 320 sets the day of the week for applying the time set in each area 312 and 316. FIG. 7 shows the state such that the power of the MFP 10 is turned on at “8:00” from “MONDAY” through “FRIDAY” (every week), and the power of the MFP 10 is turned off at “21:30” from “MONDAY” through “FRIDAY”. In other words, in the state shown in FIG. 7, the period during which the power of the MFP 10 is turned off is set as the non-usage period.

The setting area 330 relating to the monitor mode is provided, for example, below the setting area 310 relating to the automatic mode switching function. The setting area 330 relating to the monitor mode includes an area 332 for setting whether to activate the monitor mode. Inputting a check mark into the check box 334 provided in the area 332 activates the monitor mode or namely the MFP 10 is set to be in the monitor mode during the non-usage period. Removing the check mark from the check box 334 deactivates the monitor mode or namely sets the MFP 10 to be in the maximum power saver mode instead of the monitor mode during the non-usage period. Furthermore, the setting area 330 includes an area 336 for setting a mail address to serve as the destination address for above-mentioned warning mail. When an optional mail address is input into the specified field 338 provided in the area 336, a warning mail is sent to the mail address. FIG. 7 shows the state in which an optional mail address is set as the transmit destination for the warning mail along with activating the monitor mode. Also, although not shown in the drawing, if the monitor mode is deactivated or namely if the check mark is removed from the check box 334, the area 336 including the field 338 and the setting area 350 relating to the temporary canceling of the monitoring mode described below are grayed out.

The setting area 350 relating to the temporary canceling of the monitor mode is provided, for example, below the setting area 330 relating to the monitor mode. The setting area 350 relating to the temporary canceling of the monitor mode includes an area 352 for setting whether to allow the temporary canceling of the monitor mode or not. Inputting a check mark into the check box 354 provided in the area 352, allows the temporarily canceling of the monitoring mode. In addition, removing the check mark from the check box 354 prohibits the temporary canceling of the monitor mode.

Furthermore, the setting area 350 includes a first area 356, a second area 358, and a third area 360 for individually setting the above-mentioned the first through third cancel conditions. Among these areas, the area 356 is the area for setting the first cancel condition. In other words, inputting a check mark into the check box 362 provided in the area 356 deactivates the monitor mode when the first cancel condition is satisfied or in other words when the predetermined cancel time is reached. A combo box 364 for inputting the cancel time is provided in the area 356. Also, a combo box 366 for inputting the above-mentioned return time is provided in the area 356. An optional time during the non-usage period can be input into the combo boxes 364 and 366. In addition, a time subsequent to the time input in the combo box 364 can be input to the combo box 366. Although not shown in the drawing, if the check mark is removed from the check box 362 or namely if the first cancel condition is removed from conditions for canceling the monitor mode, the display of each combo box 364 and 366 and the related parts (character strings etc.) are grayed out.

The area 358 is an area for setting the second cancel condition. In other words, inputting a check mark into the check box 368 provided in the area 358 satisfies the second cancel condition or namely, when the predetermined cancel operation is performed on the MFP 10, the monitor mode is canceled. In addition, two radio buttons 370 and 372 are provided in the area 358 to select which to apply as the cancel operation from either the long-pressing of the power button 38 two times or the long-pressing of the power button 38 three times. Although not shown in the drawing, when the check mark is removed from check box 368 or in other words, if the second cancel condition is removed from the conditions for canceling the monitor mode, the display of each radio button 370 and 372, the combo boxes 364 and 366, and the related parts are grayed out.

The area 360 is an area for setting the third cancel condition. In other words, inputting a check mark into the check box 374 provided in the area 360 satisfies the third cancel condition or namely, when the predetermined password is input to the MFP 10, the monitor mode is canceled. In addition, in the area 360, a field 376 for inputting an optional password and a field 378 for re-inputting the password for confirmation are also provided. Although not shown in the drawings, if the check mark is removed from the check box 374 or namely the third cancel condition is removed from conditions for canceling the monitor mode, the display for each field 376 and 378 and the related parts are shown grayed out.

Examining the setting area 350 in FIG. 7, shows a state where conditions are set for all three of the first through third cancel conditions for canceling the monitor mode after the setting area 350 is allowed to be temporarily canceled from the monitor mode. In particular, FIG. 7 shows the state where the cancel time relating to the first cancel condition is set to “1:00” and the return time is set to “1:30”. In the cancel operation relating to the second cancel condition, FIG. 7 shows the state where the “LONG-PRESSING TWO TIMES” operation of the power button 38 is selected. Regarding the password relating to the third cancel condition, FIG. 7 shows the state where an optional password is input, however the entered password is set to hide by using the “*” marks. Although not shown in the drawing, if the check mark is removed from check box 354 or in other words, if temporary canceling of the monitor mode is prohibited, the display of the three areas 356, 358 and 360 relating to each cancel condition in the setting area 350 is grayed out.

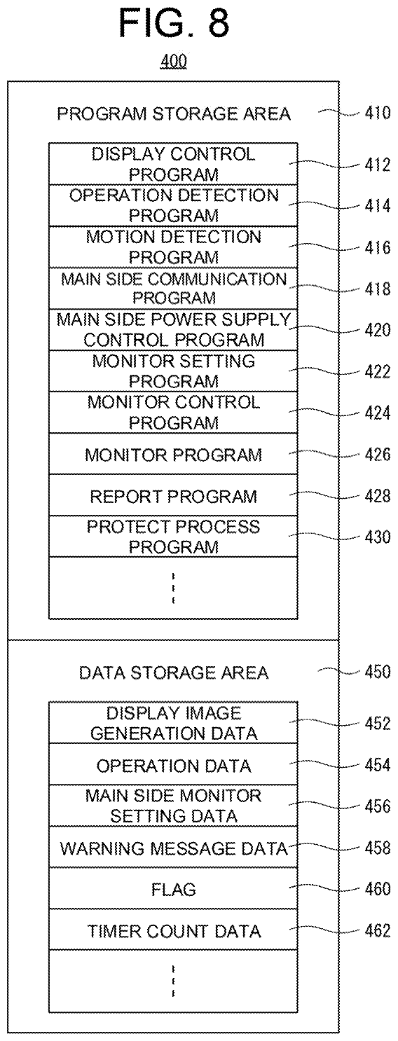

FIG. 8 is a memory map 400 showing a concept view of the configuration within the RAM of the storage 42b of the main controller 42.

As shown in the memory map 400, the RAM of the storage 42b includes a program storage area 410 and a data storage area 450. Of these storage areas, the main control program is stored in the program storage area 410. The main control program includes a display control program 412, an operation detection program 414, a motion detection program 416, a main side communication program 418, and a main side power supply control program 420. Further, the main control program includes such as a monitor setting program 422, a monitor control program 424, a monitor program 426, a report program 428, and a protect process program 430.

The display control program 412 is a program for generating the display screen data that is needed for displaying various screens such as the above-described home screen 100 on the display 32. The operation detection program 414 is a program for detecting the operated state of the touch panel 30. The operation detection program 414 is also a program for detecting the operated state of the operation key 46 including the power saver button 34 and the home button 36. The motion detection program 416 is a program for judging whether or not a person is present in the detection area. A of the motion detector 40 based on a detection signal output from the motion detector 40. The main side communication program 418 is a program for carrying out communication with the sub controller 44 (sub CPU 44a). The main side power supply control program 420 is a program for controlling the power supply 54.

The monitor setting program 422 is a program for performing settings on the setting screen 300 described above. The setting content for the setting screen 300 is stored in the auxiliary storage 50, The monitor control program 424 is a program for executing the monitor control process by the main CPU 42a as described below. The monitor program 426 is a program for executing the monitoring process by the main CPU 42a as described below. The report program 428 is a program for executing the report processing by the main CPU 42a as described below. The protect process program 430 is a program that executes the protect processing by the main CPU 42a as described below.

The data storage area 450 on the other hand stores various types of data. These various types of data include a display image generation data 452, an operation data 454, a main side monitor setting data 456, a warning message data 458, a flag 460, and a timer count data 462, etc.

The display image generation data 452 is data such as polygonal data and text data that is utilized to generate display screen data based on the above mentioned display control program 412. The operation data 454 is data representing the operated state of the touch panel 30, for more details, the operation data 454 is time-series data representing the touch position (coordinates) of the touch panel 30 by the user. The main side monitor setting data 456 is data relating to the setting contents on the setting screen 300 described above, and in particular is data relating to the operation on the main controller 42 (main CPU 42a) side. The warning message data 458 is the above mentioned warning message data (voice data) and the warning mail data (mail data). The flag 460 is various types of flags including motion detection flags. The timer count data 462 is count data for various types of timers including the motion detection deactivation timer Ta and the warning output timer Tb described below.

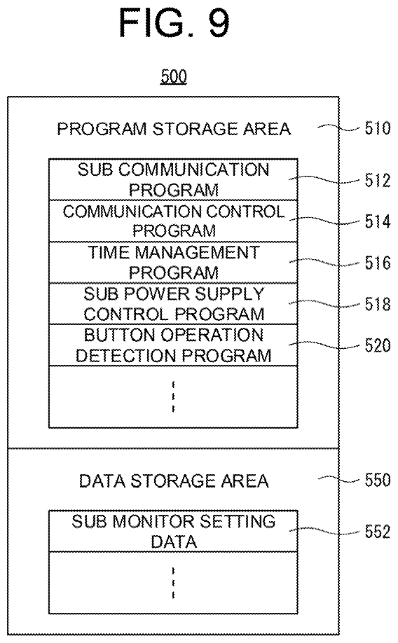

FIG. 9 shows a memory map 500 that conceptually shows the RAM internal configuration in the storage 44h of the sub controller 44.

As shown in the memory map 500, the RAM of the storage 44b includes a program storage area 510 and a data storage area 550. The above mentioned sub control program is stored in the program storage area 510. The sub control programs include such as a sub communication program 512, a communication control program 514, a time management program 516, a sub power supply control program 518, and a button operation detection program 520.

The sub communication program 512 is a program for communicating with the main controller 42 (main CPU 42a). The communication control program 514 is a program responsible for communication with external devices such as the facsimile communicator 58 and the network communicator 60. The time management program 516 is a program for managing the time by using the time manager 62. The sub power supply control program 518 is a program for controlling the power supply 54. The button operation detection program 520 is a program for detecting the operated state of the power button 38.

The data storage area 550 on the other hand, stores various types of data. These various types of data include the sub monitor setting data 552, etc. The sub monitor setting data 552 is data relating to the setting content on the setting screen 300 described above and in particular is data relating to the operation of the sub controller 44 (sub CPU 44a) side.

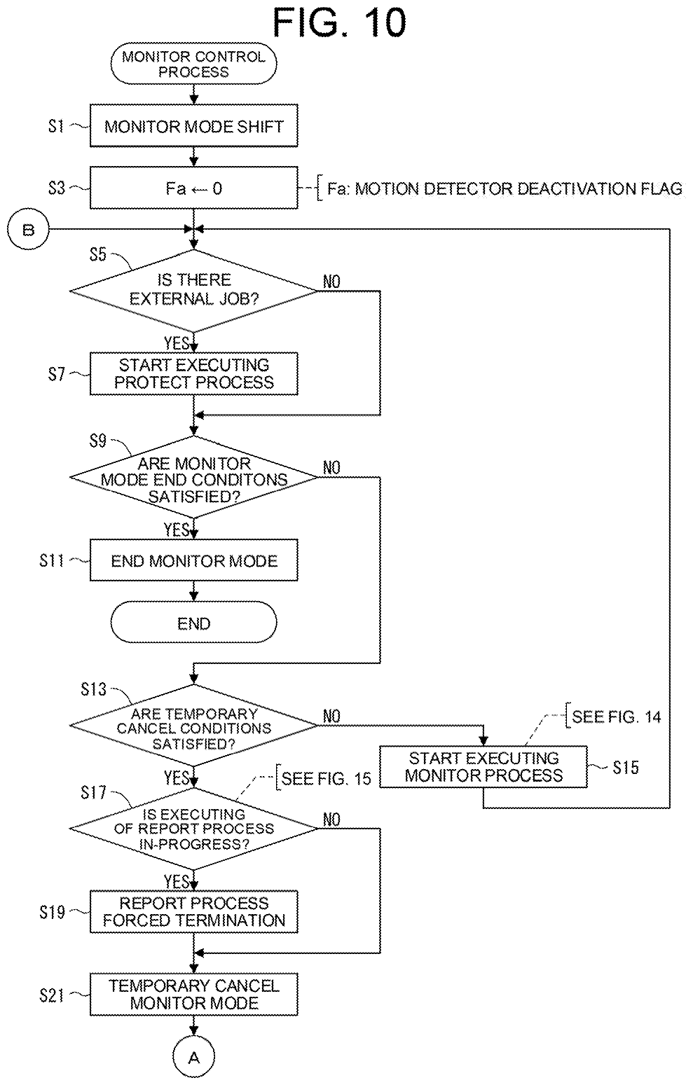

As described above, the MFP 10 according to the first embodiment has an operation mode called a monitor mode and can temporarily cancel the monitor mode. In the monitor mode, the main CPU 42a communicates with the sub CPU 44a in compliance with the above mentioned main side communication program 418 and executes the monitor control process in compliance with the monitor control program 424. The flow of the monitor control process is shown in FIG. 10 through FIG. 13. Along with the non-usage period that is set on the setting screen 300 described above, after the monitor mode is activated, the monitor control process is executed when the power-off time is reached that serves as the start time for the non-usage period.

In the monitor control process, the main CPU 42a first of all performs a process to shift to the monitor mode in step S1 shown in FIG. 10. The process in step S1 includes controlling the power supply 54. In other words, the main CPU 42a controls the power supply 54 so that the power is supplied only to certain components including the main controller 42, the sub controller 44, the motion detector 40, the facsimile communicator 58, the network communicator 60, and the time manager 62 as described above. The main CPU 42a proceeds to step S3 of the process.

In step S3, the main CPU 42a sets the motion detection deactivate flag Fa to “0 (zero)”. The motion detection deactivate flag Fa is a flag indicating that (detection results by) the motion detector 40 is deactivated. For example, when the motion detection deactivate flag Fa is “1”, the motion detector 40 is deactivated (invalidated). On the other hand, when the motion detection deactivate flag Fa is “0”, the motion detector 40 is activated (validated). After executing step S3, the main CPU 42a proceeds to step S5 of the process.

In step S5, the main CPU 42a judges whether there is an external job. The judgement is made based on communication with the sub CPU 44a. Here, for example, when there is an external job (step S5: YES), the main CPU 42a proceeds to step S7 of the process. On the other hand, if there is no external job (step S5: NO), the main. CPU 42a proceeds to step S9 of the process described below.

In step S7, the main CPU 42a starts executing the above described protect process. The external job data is consequently stored in the auxiliary storage 50. The protect process is performed by another task not shown in the drawing. The main CPU 42a proceeds to step S9 of the process.

In step S9, the main CPU 42a judges whether the condition for ending the monitor mode is satisfied or namely, whether the non-usage period has ended. Here, for example, if the condition for ending the monitor mode is satisfied (step S9: YES), the main CPU 42a proceeds to step S11 of the process. On the other hand, if the condition for ending the monitor mode is not satisfied (step S9: NO), the main CPU 42a proceeds to step S13 of the process described below.

In step S11, the main CPU 42a performs processing to terminate the monitor mode and shift to the communication mode. The process in step S11 includes controlling the power supply 54. Namely, the main CPU 42a controls the power supply 54 in order to supply power to all components of the MFP10. The main CPU 42a ends the monitor control process by executing step S11.

On the contrary, in step S13, the main CPU 42a judges whether the condition for temporarily cancelling the monitor mode is satisfied or namely, whether any of the three first through third cancel conditions are satisfied. Here, if for example the conditions for temporarily cancelling the monitor mode are not satisfied (step S13: NO), the main CPU 42a proceeds to step S15 of the process. On the other hand, if for example, the condition for temporarily cancelling the monitor mode is satisfied (step S13: YES), the main CPU 42a proceeds to step S17 of the process.

In step S15, the main CPU 42a starts executing a monitor process for monitoring the presence or absence of an intruder using the motion detector 40. The monitor process will be described in detail later. The main CPU 42a then returns to step S5 of the process.

On the contrary, in step S17, the main CPU 42a judges whether the report process described below is currently being executed, or in other words, whether the warning message is being output by the report process. Here, for example, when the report process is being executed (step S17: YES), the main CPU 42a proceeds to step S19 of the process. On the other hand, when the report process is not being executed (step S17: NO), the main CPU 42a proceeds to step S21 of the process described below.

In step S19, the main CPU 42a forcibly terminates the ongoing report process. The main CPU 42a then proceeds to step S21 of the process.

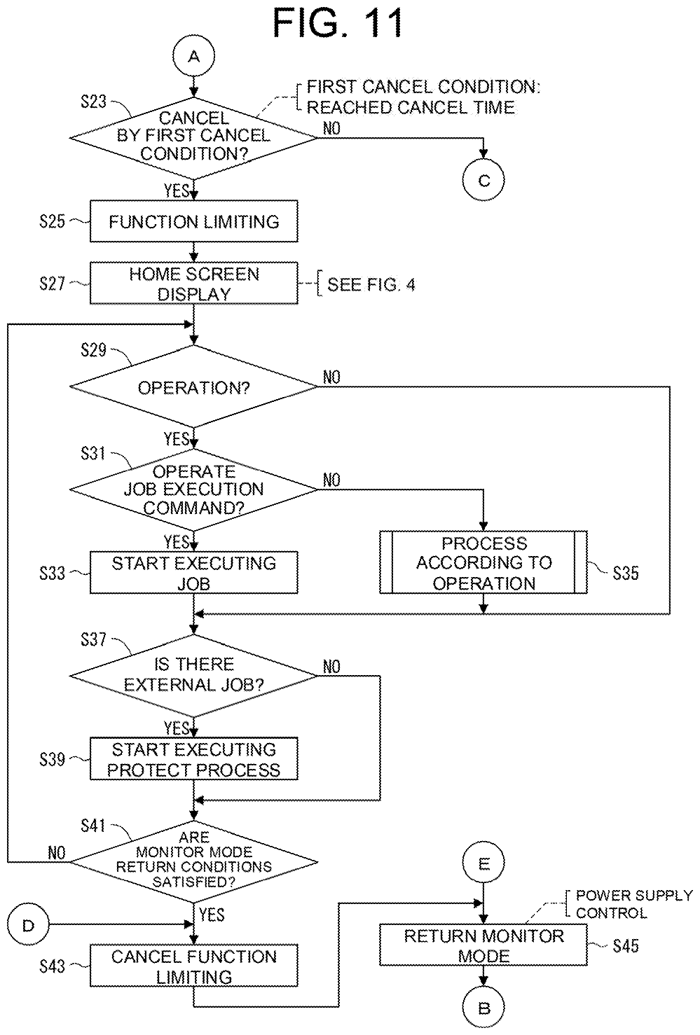

In step S21, the main CPU 42a performs processing to temporarily cancel the monitor mode. The process in step S21 includes controlling the power supply 54, Specifically, the main CPU 42a controls the power supply 54 to supply power to all components of the MFP 10 the same as when shifting to the normal mode. The monitor mode is in this way cancelled and a shift is made from the monitor mode to the so-called temporary cancel mode. The main CPU 42a then proceeds to step S23 shown in FIG. 11.

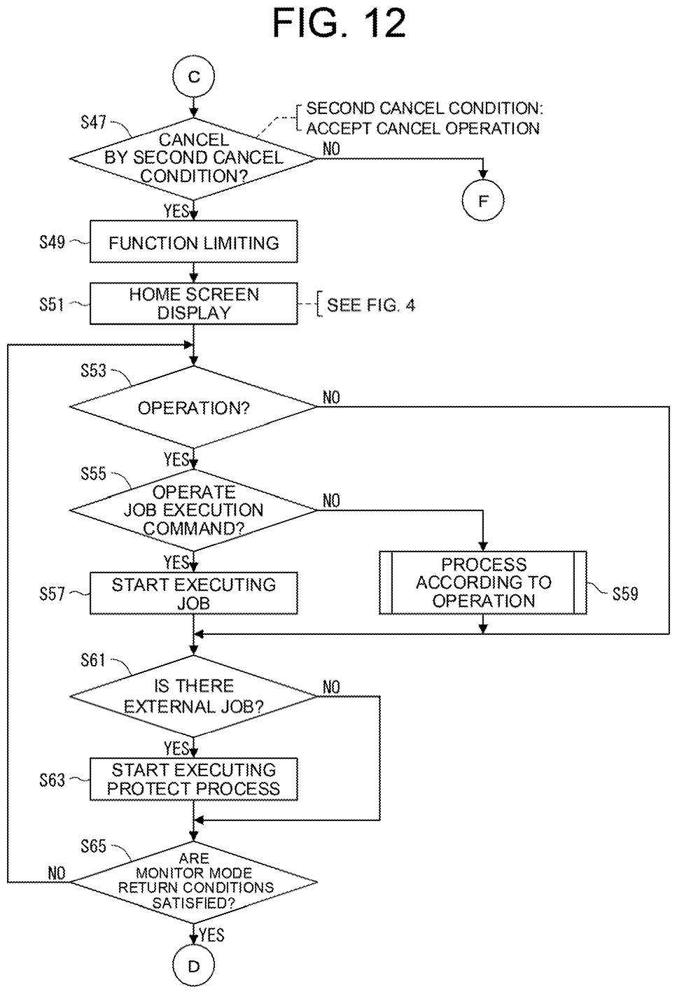

In step S23, the main CPU 42a judges whether the cause of canceling the monitor mode is the satisfying of the first cancel condition. Here, when for example, the reason for cancellation of the monitor mode is the satisfying of the first cancel condition or in other words reaching the above described cancel time for monitor mode (step S23: YES), the main CPU 42a proceeds to step S25 of the process. However, when the cause of cancelling the monitor mode is not the satisfying of the first cancel condition, or namely the monitor mode is cancelled due to satisfying the second cancel condition or the third cancel condition (step S23: NO), the main CPU 42a proceeds to step S47 of the process as shown in FIG. 12. The step S47 is described below.

In step S25, the main CPU 42a limits the functions of the MFP 10, and more specifically, allows use of only a portion of the functions including the copy function and the image scanner function on the MFP 10. The main CPU 42a then proceeds to step S27 of the process.

In step S27, the main CPU 42a displays the home screen 100 shown in FIG. 4 on the display 32. The main CPU 42a then proceeds to step S29 of the process.

In step S29, the main CPU 42a judges whether any operation has been performed on the MFP 10 including the touch panel 30, the power button 38, and the operation key 46. Here, for example, when an operation has been performed on the MFP 10 (step S29: YES), the main CPU 42a proceeds to step S31 of the process. On the other hand, if no operation is performed on the MFP 10 (step S29: NO), the main CPU 42a proceeds to step S37 of the process described below.

In step S31, the main CPU 42a judges whether the operation performed in step S29 described above is an operation instructing the execution of a job. Here, for example, if there is an operation instructing the execution of a job, (step S31: YES), the main CPU 42a proceeds to step S33 of the process. On the other hand, if the operation is not for instructing the execution of the job (step S31: NO), the main CPU 42a proceeds to step S35 of the process described below.

In step S33, the main CPU 42a starts executing the job corresponding to the operation performed in step S29 described above. The job is executed by another task not shown in the drawing. The main CPU 42a then proceeds to step S37 of the process.

In step S35 however, the main CPU 42a executes processing corresponding to the operation (that is judged) performed in step S29 described above. When the operation performed in step S29 for example is the pressing of the power button 38, the main CPU 42a does not perform any special processing. In other words, the main CPU 42a performs processing that ignores the pressing of the power button 38. The main CPU 42a then proceeds to step S37 of the process.

In step S37, the main CPU 42a judges whether there is an external job. Here, the judgement is made based on communication with the sub CPU 44a the same as in the above described step S5. If there is an external job, (step S37: YES), the main CPU 42a proceeds to step S33 of the process. On the other hand, if there is no external job (step S37: NO), the main CPU 42a proceeds to step S41 of the process described below.

In step S39, the main CPU 42a starts executing the protect process. The data from the external job is in this way stored in the auxiliary storage 50. The protect process is performed by another task not shown in the drawing the same as in the above described step S7. The main CPU 42a proceeds to step S41 of the process.

In step S41, the main CPU 42a judges whether the condition for returning the monitor mode is satisfied or namely, whether the return time is reached. Here, if for example the condition for returning the monitor mode is not satisfied, or namely the return time is not reached (step S41: NO), the main CPU 42a returns to step S29 of the process. On the other hand, if for example, condition for returning to the monitor mode is satisfied or namely if the return time is reached (step S41: YES), the main CPU 42a proceeds to step S43 of the process.

In step S43, the main CPU 42a returns the functions of the MFP 10 that are limited in step S25, back to their original state, or in other words, cancels the limiting of the functions of the MFP10. The main CPU 42a then proceeds to step S45 of the process.

In step S45, the main CPU 42a performs the process for returning the monitor mode. The process in step S45 includes controlling the power supply 54. In other words, the main CPU 42a controls the power supply 54 to supply power only to certain components including the main controller 42, the sub controller 44, the motion detector 40, the facsimile communicator 58, the network communicator 60, and the time manager 62. The main CPU 42a then returns to step S5 of the process.

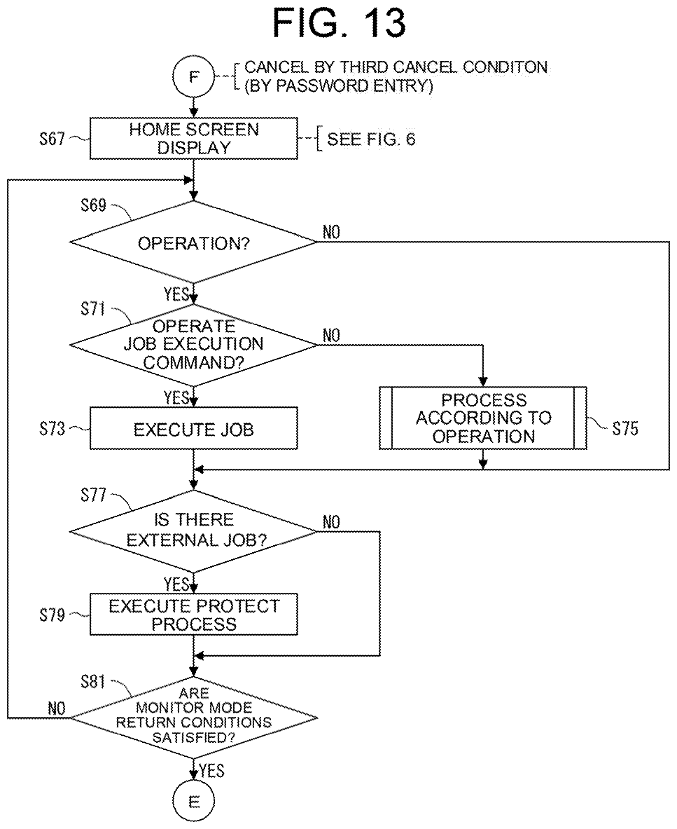

However, when the process proceeds from the above described step S23 to step S47, the main CPU 42a judges in step S47 whether the reason for canceling the monitor mode is the satisfying of the second cancel condition. Here, when for example, the reason for cancelling the monitor mode is the satisfying of the second cancel condition or in other words the monitor mode is canceled due to performing the above described canceling operation on the MFP 10 (step S47: YES), the main CPU 42a proceeds to the step S49 of the process. On the other hand, when the reason for cancelling the monitor mode is not the satisfying of the second cancel condition or namely, the monitor mode is cancelled due to satisfying the third cancel condition (step S47: NO), the main CPU 42a proceeds to the step S67 of the process as shown in FIG. 13. The step S67 is described below.

The main CPU 42a that arrives at step S49 in the process, performs the same process in steps S49 to step S65, as that in the previously described step S25 to step S41. However, in step S59 that corresponds to step S35, a portion of the process is different from the step S35. Also, the return conditions for returning to the monitor mode in step S65 that corresponds to step S41 are different. Specifically, in step S59, when the operation performed in step S53 corresponding to step S29 is the pressing of the power button 38, the main CPU 42a interprets the operation as satisfying the return condition for returning to the monitor mode. In this case, the main CPU 42a judges that the conditions for returning to the monitor mode are satisfied in step S65. In step S65, the main CPU 42a also determines that conditions for returning to the monitor mode have been satisfied even when the MFP 10 has not been used for the above described return waiting (standby) period. In other words, the return condition for returning to the monitor mode in step S65 includes not using the MFP 10 during the return waiting period. If the return condition for returning to the monitor mode is satisfied in the step S65 (step S65: YES), the main CPU 42a then proceeds to the step S43 of the process. On the other hand, if the return condition for returning to the monitor mode is not satisfied (step S65: NO), the main CPU 42a returns to step S53 of the process.

When the main CPU 42a proceeds from the above described step S47 to step S67, or namely, if the reason for canceling the monitoring mode is that the third cancel condition has been satisfied, then a display 32 shows the home screen 100 as shown FIG. 6, in the step S67. The main CPU 42a then proceeds to step S69 of the process.

In steps S69 through step S81, the main CPU 42a performs the same process as in the above described step S53 to step S65. In step S53 described above however, the acceptable operations are limited, but in step S69 corresponding to the step S53, there is no limit on the operations that can be accepted. Also, in the step S81 corresponding to the above described step S65, when the return condition for returning to the monitor mode is satisfied, or namely if the power button 38 is pressed or the MFP 10 is not used during the above mentioned return waiting (standby) period (step S81: YES), the main CPU 42a proceeds to step S45 of the process. If the return condition to the monitoring mode is not satisfied in step S81 (step S81: NO), the main CPU 42a returns to step S69 of the process.

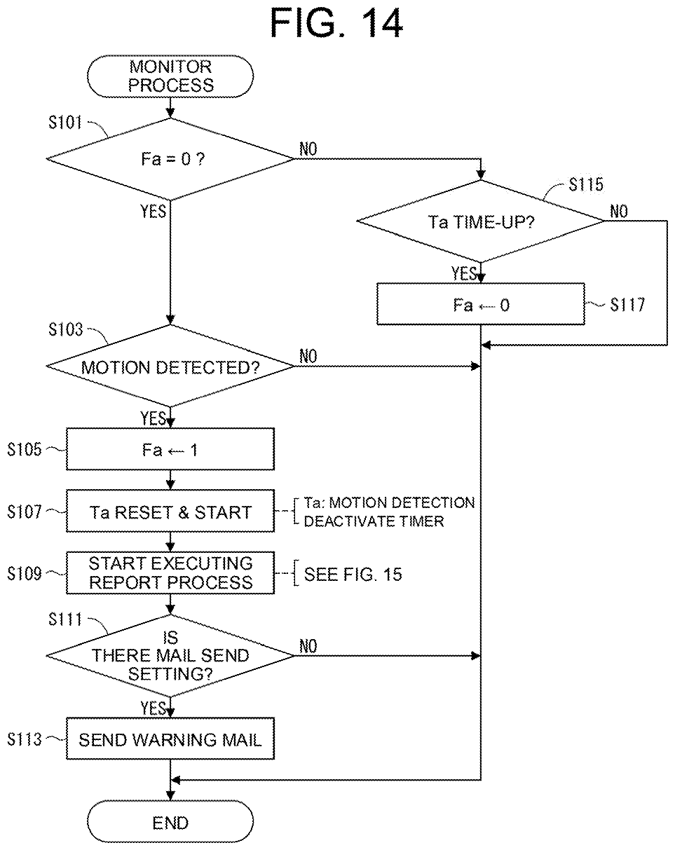

In step S15 in the type of monitor control process, execution of the monitor process is started described above, however the monitor process is performed according to the flow shown in FIG. 14. The main CPU 42a executes the monitor process corresponding to the monitor program 426 described above.

According to the monitor process, the main CPU 42a first of all judges in step S101 whether or not the above described motion detection deactivate flag Fa is “0”. Here, if the motion detection deactivate flag Fa for example is “0” (step S101: YES), the main CPU 42a proceeds to step S103 of the process. On the other hand, if in step S101 the motion detection deactivate flag Fa is “1” (step S101: NO), the main CPU 42a proceeds to step S115 of the process described below.

In step S103, the main CPU 42a judges whether or not the presence of a person has been detected by the motion detector 40. Here for example, if a person is detected (step S103: YES), the main CPU 42a proceeds to the step S105 of the process. On the other hand, if no person is detected (step S103: NO), the main CPU 42a ends the monitor process.

In step S105, the main CPU 42a sets the motion detection deactivate flag Fa to “1”. The flag indicates that the motion detector 40 has detected a person. The main CPU 42a then proceeds to the step S107.

In step S107, along with resetting the count value of the motion detection deactivation timer Ta, the main CPU 42a starts the counting operation by way of the motion detection deactivation timer Ta. The motion detection deactivation timer Ta is a timer that counts the motion detector 40 deactivation time by way of detection results and, for example, is a software timer configured from the main CPU 42a. The setting time for the motion detection deactivation timer Ta can be an optional length of time and a period of approximately several minutes to dozens of minutes is generally adequate. After executing step S107, the main CPU 42a proceeds to the step 109 of the process.

In step S109, the main. CPU 42a starts executing the report process for outputting the above described warning message from the speaker 56. The report processing is described below in detail. The main CPU 42a then proceeds to step S111 of the process.

In step S111, the main CPU 42a judges whether or not the predetermined setting for sending the above described warning mail is made or in other words, whether or not the mail address to send the warning mail is set. Here, for example, if the setting for sending a warning mail is made (step S111: YES), the main CPU 42a proceeds to step S113 of the process. On the other hand, if the setting for sending a warning mail is not made (step S111: NO), the main CPU 42a ends the monitor process.

After the main. CPU 42a proceeds from the above described step S101 to step S115 of the process, the main CPU 42a judges whether or not the count value by the motion detection deactivation timer Ta has reached the set time at the step S115, or namely whether the motion detection deactivation timer Ta has finished counting (time-up). Here, for example, when the motion detection deactivation timer Ta has finished counting (step S115: YES), the main CPU 42a proceeds to step S117 of the process. On the other hand, if the motion detection deactivation timer Ta still has not finished counting or not timed-up (step S115: NO), the main CPU 42a ends the monitor process.

In step S117, the main CPU 42a sets the motion detection deactivation flag Fa to “0”. The main CPU 42a ends the monitor process.

In the monitor process, when the motion detection deactivation flag Fa is “1” as described above, the motion detector 40 is deactivated until the motion detection deactivation timer Ta finishes counting up (time-up). The deactivation prevents causing inconvenience due to the same person being detected by the motion detector 40 and in particular, the deactivation prevents the warning message from being output many times.

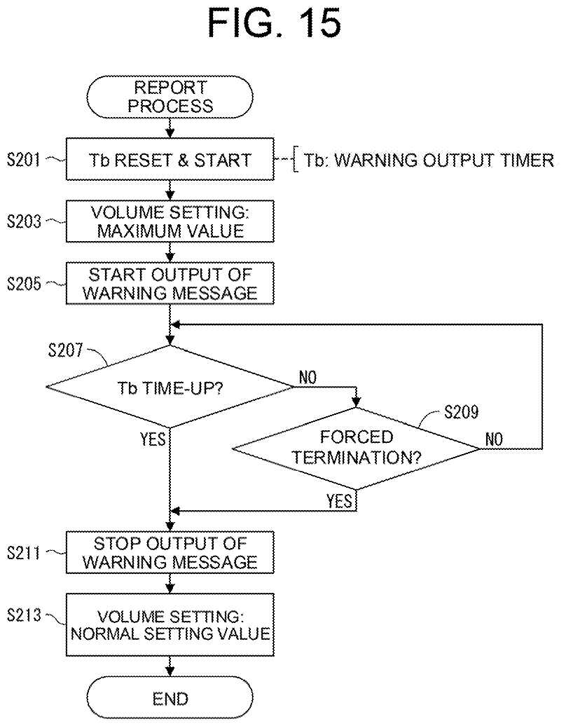

In step S109 in the monitor process, execution of the report process starts as described above, however the report process is performed according to the flow shown in FIG. 15. The main CPU 42a executes the report process according to the report program 428 described above.

In the report process, the main CPU 42a first of all in step S201, resets the count value of the warning output timer Tb and starts the count operation by the warning output timer Tb. The warning output timer Tb is a tinier for counting the time to output the warning message and for example is a software timer configured from the main CPU 42a. The setting time of the warning output timer Tb can be an optional length and for example an appropriate setting is from several minutes to several dozen minutes. After executing the step S201, the main CPU 42a proceeds to step S203 of the process.

In step S203, the main CPU 42a sets the output volume of the speaker 56 to the maximum value or namely controls the speech processor 52 to set that maximum value. The main CPU 42a then proceeds to step S205 of the process.

In step S205, the main CPU 42a starts outputting a warning message from the speaker 56. The main CPU 42a then proceeds to step S207 of the process.

In step S207, the main CPU 42a judges whether the count value by the warning output timer Tb has reached the setting time or namely whether the warning output timer Tb has finished counting (time-up). Here, for example, when the warning output timer Tb has finished counting (time-up) (step S207: YES), the main CPU 42a proceeds to step S211 of the process described below. On the other hand, if the warning output timer Tb still has not finished counting (or not timed-up) (step S207: NO), the main CPU 42a proceeds to step S209 of the process.

In step S209, the main CPU 42a judges whether forcibly terminating the report process is necessary due to execution of step S19 (See FIG. 10) in the above described monitor control process or namely, due to the MFP 10 shifting to the monitor mode. Here, for example, when it is not necessary to forcibly terminate the report process (step S209: NO), the main CPU 42a returns to step S207 of the process. On the other hand, when it is necessary to forcibly terminate the report process (step S209: YES), the main CPU 42a proceeds to step S211 of the process.

In step S211, the main CPU 42a stops outputting a warning message from the speaker 56. The main CPU 42a then proceeds to step S213 of the process.

In step S213, the main CPU 42a returns the output volume of the speaker 56 to the normal setting value, and specifically, returns to the state before the above described step S203 is executed. By executing the step S213, the main CPU 42a ends the report process.

The MFP 10 according to the first embodiment in this way includes a monitor function for detecting the presence or absence of an intruder by way of the motion detector 40. The monitor function is achieved by the monitor mode however the monitor mode can be temporarily canceled. Therefore, for example, when the MFP 10 is in the monitor mode, there is a request from a user wanting to use an original function of the MFP 10 such as the copy function, a flexible response can be made to the user request.

In the first embodiment, when the main CPU 42a executes the above described report process (see FIG. 15), a warning message is output from the speaker 56. The main CPU 42a that executes this type of report process along with the speech processor 52 and the speaker 56 is an example of the reporter according to the present invention.

Also, according to the above described monitor control process (see FIGS. 10 to 13), when the monitor mode is temporarily canceled or namely, when the conditions for canceling the monitor mode are satisfied, the monitor process is not executed or namely the monitor process (Refer to FIG. 14) is deactivated. The main CPU 42a that avoids executing the monitor process in this way is an example of the deactivator according to the present invention.

Further, in the monitor control process, particularly in step S25 or in step S49, the main CPU 42a limits the functions of the MFP 10 and this type of the main CPU 42a is an example of the limiter according to the present invention. In step S25 and step S49 the functions of the MFP 10 are limited in the same way, but there may be a difference in the extent (content) of the function limiting of the MFP 10. For example, in either of the step S25 and step S49; the functions of the MFP 10 may be more greatly limited or the limiting of the functions may be eased. In other words, the extent of the limiting of the functions of the MFP 10 may be set according to the reason that temporarily cancelled the monitor mode or in other words, whether the monitor mode is temporarily cancelled by the satisfying of any of the first through third cancel conditions.

Also, in the monitor control process, especially in step S41, step S65 or step S81, if the return condition for returning to the monitor mode is satisfied, the MFP 10 will return to the monitor mode, and specifically will be executed in step S45. The main CPU 42a that executes the monitor control process including the step S45 is also an example of the activator according to the present invention.

### Second Embodiment

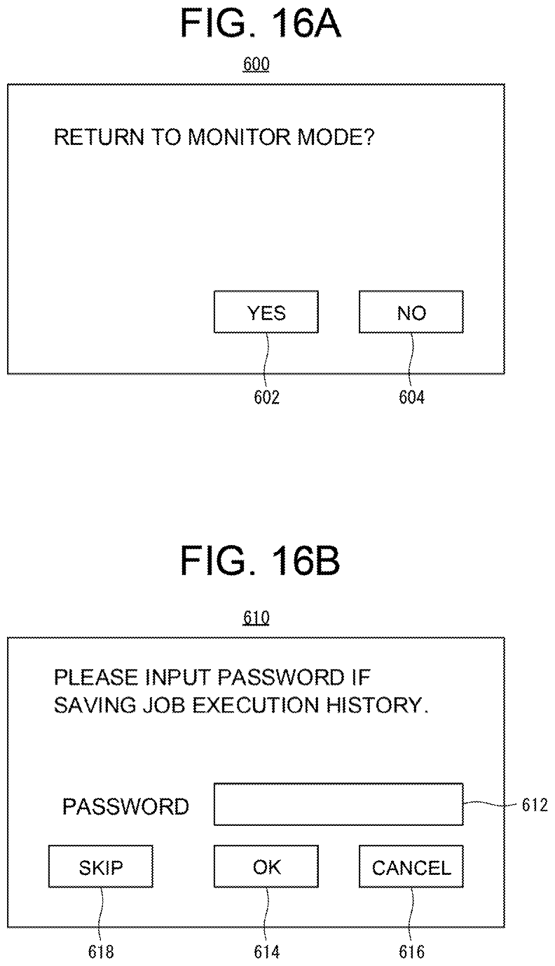

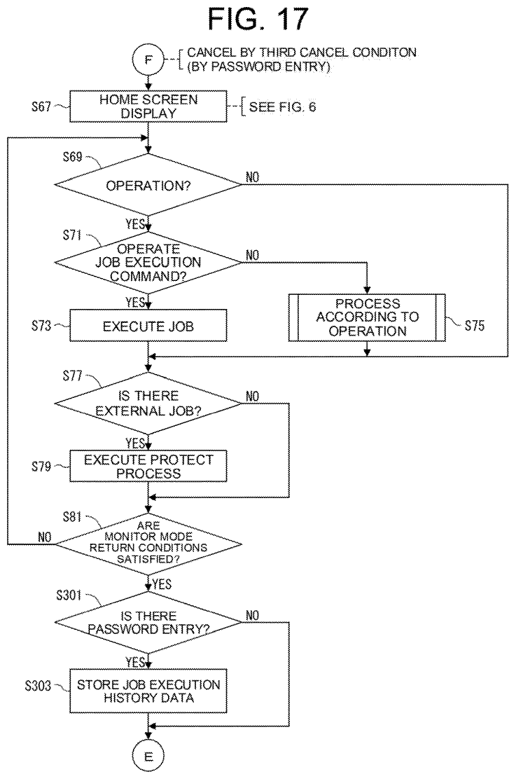

The second embodiment of the present invention is described while referring to FIGS. 16A and 16B and FIG. 17.

In the second embodiment, during the period when the monitor mode is temporarily cancelled, or in other words, during the period when the MFP 10 is in temporary cancel mode, the history data relating to the history of jobs executed by the MFP 10 can be stored. The other points of the second embodiment are identical to the points in the first embodiment so a description of the same points as in the first embodiment is omitted.

There are several conditions for saving the history data in the second embodiment. A current condition includes that the above described third cancel condition is satisfied or namely that the monitor mode is temporarily canceled by the entry of a predetermined password. In addition, when the above described return operation is performed on the MFP 10, the MFP 10 is returned to the monitor mode and in that case, the entry of the same password to the MFP 10 as that input when the monitor mode is temporarily canceled on the MFP 10 is included among the conditions for storing the history data. In other words, the monitor mode is temporarily canceled by satisfying the third cancel condition and further, performing a predetermined operation on the MFP 10 returns the MFP 10 to the monitor mode and inputting the predetermined password at that time saves the history data.

Specifically, when the above described return operation is performed for the MFP 10 with the monitor mode that is temporarily canceled due to satisfying the third cancel condition, the check screen 600 as shown in FIG. 16A appears on the display 32. When the button 602 with the character string “YES” is pressed on the check screen 600, or in other words, that operation is performed on the touch panel 30, a password entry screen 610 as shown in FIG. 16B appears on the display 32 instead of the check screen 600. When a predetermined password is input in the field 612 for inputting a password in the password entry screen 610 and the button 614 with the character string “OK” is pressed, the MFP 10 returns to the monitor mode. At that time, history data is saved and the history data is stored for example in the auxiliary storage 50.

The history data referred to here is an example of history information according to the present invention. Storage of the history data in the auxiliary storage 50 is performed in compliance with the control by the main CPU 42a. The main CPU 42a that performs storage of the history data forms an example of the storage device according to the present invention in cooperation with the auxiliary storage 50. Further, the password input when storing the history data is an example of the second information according to the present invention. In addition, the entry of the password when storing the history data is an example of the second information entry condition according to the present invention or namely is an example of the storage condition.

Incidentally, if the password entered in the field 612 of the password entry screen 610 does not match the preset password, a message indicating that the password authentication failed is shown or in other words, an error message screen (not shown in the drawing) appears on the display 32. The error message screen is displayed instead of the password entry screen 610 or in the form of a dialog on the password entry screen 610 for a certain period for example, from several seconds to several dozen seconds. The MFP 10 then returns to the state before the above described return operation. Also, when the button 616 with the character string “CANCEL” is pressed on the password entry screen 610, the MFP 10 returns to the state prior to the performing of the return operation. Further, when the button 618 with the character string “SKIP” is pressed on the password entry screen 610, the MFP 10 returns to the monitor mode without saving the history data. When the button 604 with the character string “NO” is then pressed on the above described check screen 600, the MFP 10 returns to the state prior to performing return operation.

To save this type of history data, in the above described monitor control process, particularly in step S81 (see FIG. 13) when the return condition for returning to the monitor mode is satisfied (step S81: YES), the main CPU 42a proceeds to step S301 shown in FIG. 17. In the step S301, the main CPU 42a judges whether the return condition satisfied in step S81 includes the entry of the password. Here, for example, when the entry of the password is included (step S301: YES), the main CPU 42a proceeds to step S303 of the process. On the other hand, when the entry of a password is not included (step S301: NO), the main CPU 42a returns to step S45 of the process.

In step S303, the main CPU 42a stores history data relating to jobs executed during the period in which the monitor mode is temporarily canceled in the auxiliary storage 50. The main CPU 42a then returns to step S45 of the process.

The second embodiment as described above is capable of storing history data relating to the history of the job executed during the period in which the monitor mode is temporarily canceled.

In the second embodiment, a condition for saving history data includes that the monitor mode is temporarily canceled due to satisfying of the third cancel condition, however other configurations may also be employed. For example, any structure that stores the history data is acceptable regardless of which of the above described first through third cancel conditions is satisfied as the reason for cancelling the monitor mode. In such cases, there is no need to request entry of a password as a condition.

### Other Examples

Each of the above examples is a specific example of the present invention and does not limit the technical scope of the present invention. The present invention can also be applied to aspects other than these embodiments.

For example, if the monitor mode is temporarily cancelled, information on the reason for cancellation of the monitor mode, or namely information on cancelling of a monitor mode that satisfies any of the above described first through third cancel conditions configured as shown in display 32 may be employed.

Also, in each of the embodiments, the monitor mode is temporarily canceled when any of the three of the first through third cancel conditions is satisfied, however the invention is not limited to the arrangement. The monitor mode may be temporarily cancelled when all or any combination of the three cancel conditions are satisfied. Further, conditions other than the three cancel conditions may be provided. For example, performing authentication by utilizing an Integrated Circuit (IC) card storing predetermined identification information may be provided as a cancel condition.

The present invention is further not limited to the content described in each embodiment even for return conditions for returning the MFP 10 to the monitor mode. For example, a dedicated button for returning the MFP 10 to the monitor mode is provided, and the operating of the dedicated button is included in the return conditions.

Also, when returning the MFP 10 to the monitor mode by performing a predetermined return operation including the operation of the dedicated button described above on the MET 10, an appropriate waiting (standby) time may be provided for performing (for example until the start of) returning to the monitor mode. In other words, the MFP 10 may also be configured to return to the monitor mode when an appropriate waiting (standby) time has elapsed after performing a predetermined return operation on the MFP 10. This configuration allows avoiding the problem of detecting the genuine user as an intruder (false detection) when the MFP 10 returns to the monitor mode by performing a predetermined return operation on the MFP 10.

The functions of the MFP 10 are limited when the monitor mode is temporarily canceled due to satisfying the first cancel condition or the second cancel condition, but the present invention is not limited to the arrangement. Namely, a configuration may be employed that does not limit the functions of the MFP 10 even if the monitor mode is temporarily canceled. In other words, the MFP 10 may be configured to shift from the monitor mode to the normal mode when the monitor mode is temporarily canceled.

Further, when outputting the above described warning message from the speaker 56, an appropriate warning screen may also be shown on the display 32. In this case, the power supply 54 must also supply power to the display 32.

In addition, the above described protect process need only be implemented when a predetermined setting is made beforehand. In other words, if there is no predetermined setting made here in advance, then the normal process may be performed instead of the protect process. In this case, when an external job such as a print job or a facsimile receive job is accepted, then a process that matches the job is performed. However, protect process is preferably performed from the standpoint of security.

The motion detector 40 may be configured so that for example, the detection area A changes when the MFP 10 is in the monitor mode and when the MFP 10 is not in the monitor mode. In particular, the motion detector 40 may be configured to widen the detection area A when the MFP 10 is in the monitor mode compared to when the MFP 10 is not in the monitor mode in order to allow detecting the presence or absence of intruders over a wide range which enhances the monitoring function.

Also, a pyroelectric sensor which is a kind of infrared sensor is adopted as the motion detector 40, but the present invention is not limited to a pyroelectric sensor. For example, an infrared sensor other than a pyroelectric sensor, or an ultrasonic sensor or a visible light sensor other than the infrared sensor may be utilized. Moreover instead of or in addition to the motion detector 40, other detectors such as cameras or mat sensors (mat switches) may be employed.

The main controller 42 and the sub controller 44 described above need not be separate from each other, and may be configured together into one controller.

The examples of the present invention are described as applicable to the MFP 10. However, the present invention is not limited to the arrangement and the present invention may of course apply to information processing apparatuses other than the MFP 10.

What is claimed is:

1. An information processing apparatus comprising:
a period setter that sets a non-usage period that the information processing apparatus is not used,
a detector that detects whether a person is present within a predetermined area around the information processing apparatus,
a reporter that reports a detection of a presence of a person when the detector detects the presence of the person during the non-usage period, and
a deactivator that deactivates the reporter when a predetermined deactivation condition is satisfied during the non-usage period.

2. The information processing apparatus according to claim 1,
wherein the deactivator deactivates the reporter when at least one or all of a plurality of predetermined deactivation conditions are satisfied.

3. The information processing apparatus according to claim 1, further comprising a limiter that limits functions of the information processing apparatus when the reporter is set in a deactivated state by the deactivator.

4. The information processing apparatus according to claim 2, further comprising a limiter that limits the functions of the information processing apparatus when the reporter is set in a deactivated state by the deactivator,
wherein the limiter limits the functions of the information processing apparatus according to the extent of satisfied deactivation conditions when the reporter is deactivated because at least one of the plurality of deactivation conditions is satisfied.

5. The information processing apparatus according to claim 1,
wherein the deactivation condition includes a first time condition that is reaching of a predetermined first time.

6. The information processing apparatus according to claim 1,
wherein the deactivation condition includes a first operation condition that a predetermined first operation is performed for the information processing apparatus.

7. The information processing apparatus according to claim 1,
wherein the deactivation condition includes a first, information entry condition that a predetermined first information is input for the information processing apparatus.

8. The information processing apparatus according to claim 1, further comprising an activator that activates the reporter when the predetermined activation condition is satisfied in a state that the reporter is deactivated by the deactivator.

9. The information processing apparatus according to claim 8,
wherein the activation condition includes a second time condition that is reaching of a predetermined second time.

10. The information processing apparatus according to claim 8,
wherein the activator includes a second operation condition that a predetermined second operation is performed for the information processing apparatus.

11. The information processing apparatus according to claim 8,
wherein the activator includes a non-usage condition that the information processing apparatus is not used during a predetermined period.

12. The information processing apparatus according to claim 1, further comprising a storage device that stores history information relating to a history of processing performed by the information processing apparatus when the reporter is in a state that the reporter is deactivated by the deactivator.

13. The information processing apparatus according to claim 12,
wherein the storage device stores the history information when a predetermined storage condition is satisfied.

14. The information processing apparatus according to claim 13,
wherein the storage condition includes a second information entry condition that a predetermined second information is input for the information processing apparatus.

15. The information processing apparatus according to claim 1,
wherein the information processing apparatus is a multifunction peripheral.

16. A non-transitory computer-readable recording medium that records a monitor control program in an information processing apparatus including a detector that detects whether a person is present within a predetermined area around a machine main body, the monitor control program causing a computer for the information processing apparatus to execute:
a period setting procedure that sets a non-usage period that the information processing apparatus is not used,
a report procedure that reports a detection of a presence of a person when the detector detects the presence of the person during the non-usage period, and
a deactivation procedure that does not execute the report procedure when a predetermined deactivation condition is satisfied during the non-usage period.

17. A monitor control method in an information processing apparatus that includes a detector that detects whether a person is present within a predetermined area around a machine main body, and the monitor control method comprising:
setting a non-usage period that the information processing apparatus is not used,
reporting a detection of a presence of a person when the detector detects the presence of the person during the non-usage period, and
deactivating that does not execute the reporting when a predetermined deactivation condition is satisfied during the non-usage period.
